(19) United States
(12) Patent Application Publication
(10) Pub. No.: US 2021/0017898 A1
(43) Pub. Date: Jan. 21, 2021

(54) FLOATING CORE HEAT EXCHANGER

(71) Applicant: DEERE & COMPANY, MOLINE, IL (US)

(72) Inventor: GLEN H. MARTIN, III, WATERLOO, IA (US)

(21) Appl. No.: 16/513,276

(22) Filed: Jul. 16, 2019

(51) Int. Cl. F02B 29/04; F02M 26/32; F02M 26/12

(52) U.S. Cl. CPC F02B 29/0462; F02B 29/0443; F02M 26/12; F02M 26/32

(57) ABSTRACT

An internal combustion engine having an exhaust gas recirculation system includes a heat exchanger having a core configured to circulate a first fluid therethrough, a housing surrounding the core, and at least one coupler disposed between the core and the housing. The housing is configured to circulate a second fluid therethrough and across the core. The first fluid is different from the second fluid. The core includes a housing interface portion whereby the core interfaces with the housing to allow rotational and axial displacement between the core and the housing. The at least one coupler is configured to rotationally couple the core to the housing.

### BACKGROUND

Internal combustion engines, including diesel, gasoline, propane, and natural gas engines, produce exhaust gas containing carbon monoxide, hydrocarbons, and nitrogen oxides (NOx). These emissions may be the result of incomplete combustion. Diesel engines may also produce particulate matter. Government agencies around the world continue to enact more stringent emissions laws requiring further reduction in emissions from internal combustion engines.

One technique for reducing NOx in engine emissions involves introducing chemically inert gases into the fresh air flow stream for subsequent combustion. By reducing the oxygen concentration of the resulting charge to be combusted, the fuel burns slower and peak combustion temperatures are accordingly reduced, thereby lowering the production of NOx. In an internal combustion engine environment, such chemically inert gases are readily abundant in the form of exhaust gases, and a method for achieving the foregoing result is through the use of an exhaust gas recirculation (EGR) system operable to controllably introduce (i.e., recirculate) exhaust gas from the exhaust manifold into the fresh air stream flowing to an intake manifold. EGR systems may include one or more heat exchangers, also referred to as EGR coolers, to reduce the temperature of the exhaust gas during recirculation.

### SUMMARY

Various aspects of examples of the present disclosure are set out in the claims.

In accordance with an embodiment of the present disclosure, a heat exchanger is provided. The heat exchanger includes a core configured to circulate a first fluid therethrough, a housing surrounding the core, wherein the housing is configured to circulate a second fluid therethrough and across the core, wherein the first fluid is different from the second fluid, and wherein the core includes a housing interface portion whereby the core interfaces with the housing to allow rotational and axial displacement between the core and the housing, and at least one coupler disposed between the core and the housing, wherein the at least one coupler is configured to rotationally couple the core to the housing.

In accordance with an embodiment of the present disclosure, an internal combustion engine having an exhaust gas recirculation system configured to recirculate exhaust gas is provided. The exhaust gas recirculation system includes a core configured to circulate exhaust gas therethrough, a housing surrounding the core, wherein the housing is configured to circulate coolant therethrough and in a heat-exchanging relationship with the core, and wherein the core includes a housing interface portion whereby the core interfaces with the housing to allow rotational and axial displacement between the core and the housing, and at least one coupler disposed between the core and the housing, wherein the at least one coupler is configured to rotationally couple the core to the housing.

The above and other features will become apparent from the following description and accompanying drawings.

### BRIEF DESCRIPTION OF THE DRAWINGS

The detailed description of the drawings refers to the accompanying figures in which:

FIG. 1 illustrates an internal combustion engine in accordance with an embodiment of the present disclosure;

FIG. 2 illustrates a heat exchanger in accordance with an embodiment of the present disclosure;

FIG. 3 is an enlarged cross sectional view of a heat exchanger in accordance with an embodiment of the present disclosure;

FIG. 4 is an enlarged cross sectional view of a heat exchanger in accordance with an embodiment of the present disclosure; and

FIG. 5 is an enlarged cross sectional view of a heat exchanger in accordance with an embodiment of the present disclosure.

Like reference numerals are used to indicate like elements throughout the several figures.

### DETAILED DESCRIPTION

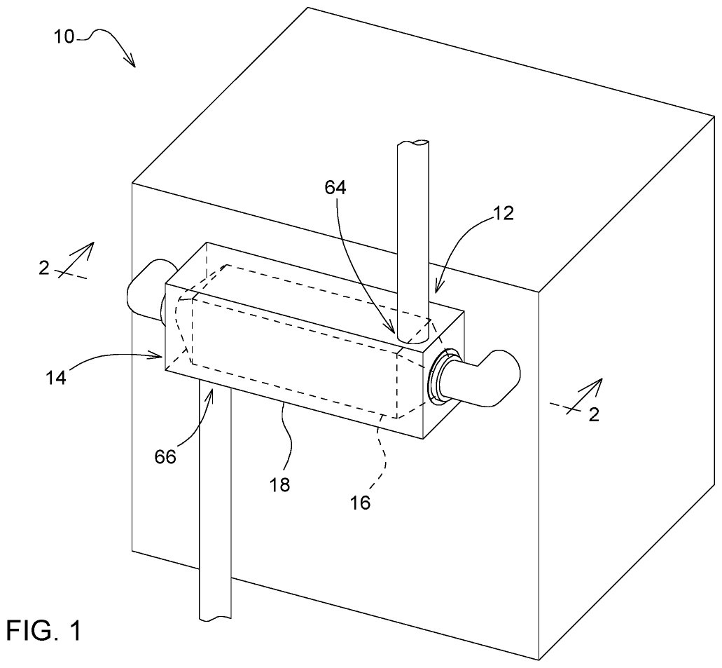

At least one example embodiment of the subject matter of this disclosure is understood by referring to FIGS. 1 through 5 of the drawings.

Referring now to FIG. 1, an internal combustion engine 10 is illustrated in accordance with an embodiment of the present disclosure. Although the illustrated engine 10 is a diesel engine, the engine 10 of various embodiments may utilize any other fuel type, cycle, or operational principle resulting in the production of exhaust gas. The engine 10 of the illustrated embodiment includes an exhaust gas recirculation (EGR) system 12 configured to recirculate exhaust gas. In the embodiment illustrated in FIG. 1, the EGR system 12 is fixed or coupled to the engine 10 such that any vibration, oscillation, or other operational kinetic energy may be transmitted, at least partially, to one or more components or portions of the EGR system 12.

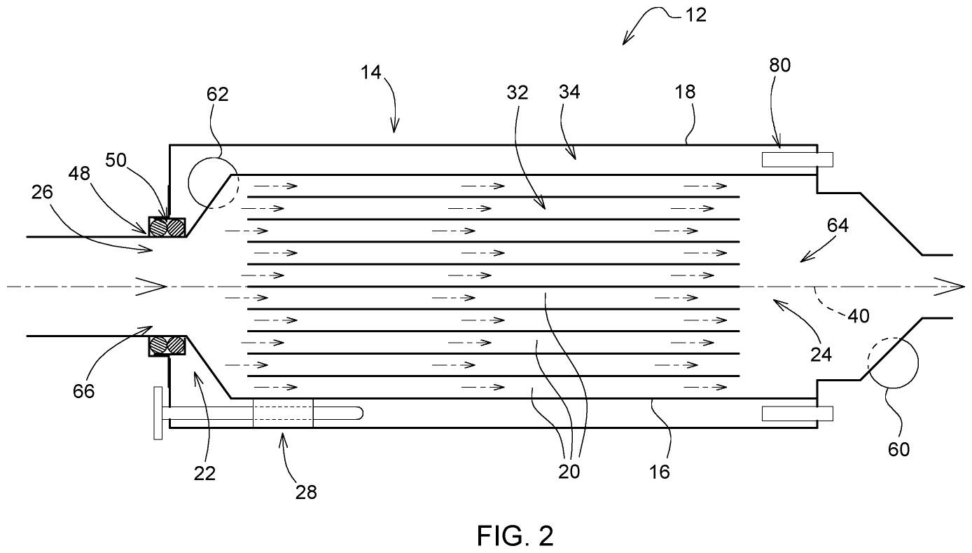

Referring now to the embodiment of FIG. 2, the EGR system 12 includes a heat exchanger 14, which may be referred to as an EGR cooler in one or more embodiments herein. The heat exchanger 14 of the EGR system 12 of an embodiment includes a core 16 and a housing 18 containing, enclosing, encircling, or otherwise at least partially surrounding the core 16. The heat exchanger 14 and/or the EGR system 12 is configured to allow a first fluid to circulate through the core 16 from a first fluid port 64 to a second fluid port 66 at opposing ends of the core 16. In the illustrated embodiment, exhaust gas from the engine 10 circulates through the core 16. The heat exchanger 14 of the EGR system 12 of the illustrated embodiment is configured to circulate the exhaust gas axially through the core 16 generally along axis 40.

The housing 18 is configured to circulate a second fluid therethrough. The housing 18 of FIG. 2 includes an intake port 60 configured to introduce the second fluid into the housing 18 and a discharge port 62 configured to receive the second fluid from the housing 18. The second fluid of an embodiment is different from the first fluid. In the illustrated embodiment, the second fluid is coolant. Further, the housing 18 of the illustrated embodiment is configured to circulate coolant in a heat-exchanging relationship with the core 16. The core 16 of the illustrated embodiment includes a plurality of fluid passages 20 having surface area and geometry configured to enhance heat transfer from the exhaust gas to the coolant. The core 16 defines a first fluid chamber 32 configured to circulate the exhaust gas. The core 16 and the housing 18 define a second fluid chamber 34 configured to allow the coolant to circulate therethrough.

The heat exchanger 14 of the illustrated embodiment may be referred to as a “floating core” heat exchanger or EGR cooler as the core 16 of the heat exchanger 14 of the illustrated embodiment is supported in the housing 18 at a first end 22 and a second end 24 of the core 16. Due to the significant temperature differences that may exist between the core 16 and the housing 18, such support allows thermal expansion, contraction, or other movement or displacement of the core 16 and/or between the core 16 and the housing 18. The heat exchanger 14 of the illustrated embodiment includes the core 16 being axially and rotationally fixed to the second end 24 by one or more fasteners 80. However, the core 16 interfaces with the housing 18 at a housing interface portion 26 to allow rotational and axial displacement between the core 16 and the housing 18 in the illustrated embodiment. In another embodiment not shown, rotational and/or axial displacement between the core 16 and the housing 18 is allowed at both the first end 22 and the second end 24 of the core 16.

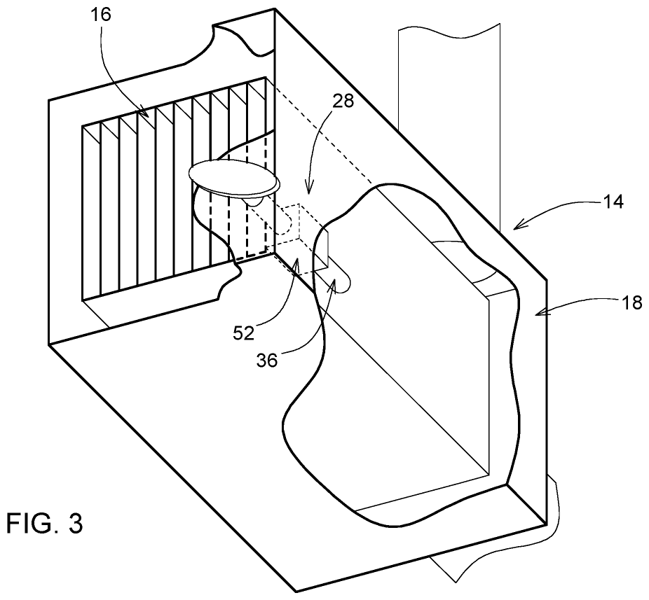

Referring now to FIGS. 3-5, the heat exchanger 14 includes one or more coupler(s) 28 disposed between the core 16 and the housing 18. The coupler 28 is configured to rotationally or torsionally couple the core 16 to the housing 18, such as in response to or to minimize or reduce reaction by the EGR system 12, and, in particular, the core 16 of the EGR system 12, to certain vibrational frequencies that may result in a twisting or torsional oscillation, movement, displacement, or vibration of the core 16 relative to the housing 18. Such vibrational frequencies may be caused by operational frequencies of the engine 10, a vehicle operation connected to the engine 10, or another vibrational or energy source in various embodiments.

The coupler 28 of one or more embodiments is configured to allow axial displacement between the core 16 and the housing 18. In the embodiments illustrated in FIGS. 3-5, the coupler 28 is disposed between the core 16 and the housing 18 at the housing interface portion 26 of the core 16. Further, in the embodiments shown, the coupler 28 is disposed radially, relative to axis 40, between the core 16 and the housing 18. The core 16 of an embodiment is composed of steel or another ferrous material due to its exposure to the high temperature exhaust gas, but the coupler 28 of an embodiment is composed at least partially of aluminum in a non-limiting example as the coupler 28 is disposed in the flow path of the coolant between the core 16 and the housing 18 and is, therefore, not subjected to as high of temperatures in the illustrated embodiment. Although the coupler 28 is shown as being disposed at the first end 22 of the core 16 in the illustrated embodiments, the coupler 28 may be disposed at the second end 24 or both the first end 22 and the second end 24 in additional embodiments.

As shown in FIG. 2 and further shown in FIGS. 3-5, the core 16 interfaces with the housing 18 at the first end 22 via a round or annular engagement 48. In an embodiment, one or more seals 50, such as two O-rings in the illustrated embodiment to name a non-limiting example, are provided at the engagement 48 to prevent or minimize leakage of coolant. As discussed herein, relative axial and/or rotational or torsional movement or displacement between the core 16 and the housing 18 is permitted at the engagement 48.

Referring to FIG. 3, the coupler 28 of an embodiment includes one or more pin(s) 36 and pin receiver(s) 52 configured to rotationally or torsionally couple the core 16 to the housing 18 or at least limit rotational or torsionally displacement between the core 16 and the housing 18 and allow axial displacement between the core 16 and the housing 18. In the illustrated embodiment of FIG. 3, the pin 36 remains fixed to the housing 18 while the pin receiver 52 is fixed to the core 16. Accordingly, the pin receiver 52 and the core 16 remain rotationally or torsionally restrained with the housing 18 while being allowed to move axially relative to the housing 18. Although one pin 36 and receiver 52 is shown in FIG. 3, any number, arrangement, or geometry may be included in order to perform the function described herein.

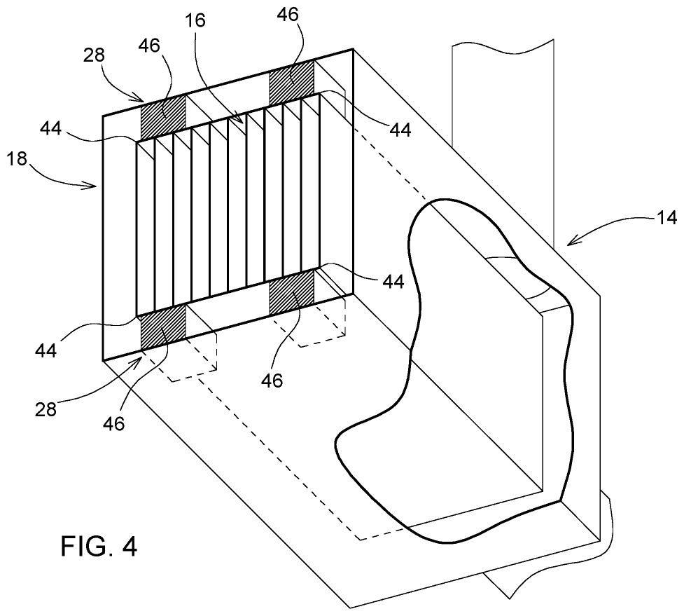

Referring to FIG. 4, the core 16 includes a plurality of radially outer corners 44. In an embodiment, the coupler 28 includes a plurality of inserts 46 such that each of the plurality of inserts 46 is disposed at each of the plurality of radially outer corners 44. The plurality of inserts 46 is configured to rotationally or torsionally couple the core 16 to the housing 18 or at least limit rotational or torsional displacement between the core 16 to the housing 18 and allow axial displacement between the core 16 and the housing 18. In an embodiment, the plurality of inserts 46 is coupled to or formed integrally with the housing 18 such that the core 16 remains rotationally or torsionally restrained with the inserts 46 and the housing 18 while being allowed to move axially relative to the housing 18. In another embodiment, the inserts 46 may be coupled to or formed integrally with the core 16 such that the inserts 46 may displace axially with the core 16 relative to the housing 18. Although four inserts 46 are shown in FIG. 4, any number, arrangement, or geometry may be included in order to perform the function described herein.

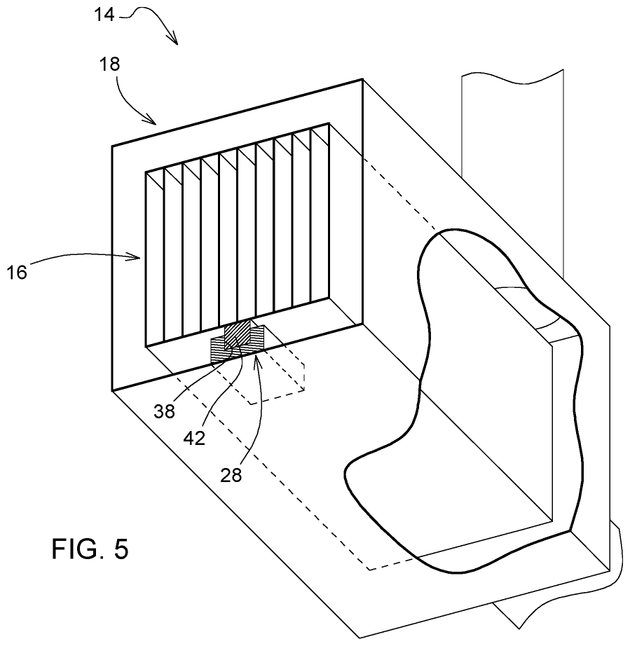

Referring to FIG. 5, the coupler 28 of an embodiment includes one or more rail(s) 42 and/or slot(s) 38 configured to engage to rotationally or torsionally couple the core 16 to the housing 18 or at least limit rotational or torsionally displacement between the core 16 and the housing 18 and allow axial displacement between the core 16 and the housing 18. In the illustrated embodiment of FIG. 5, the slot 38 remains fixed to the housing 18 while the rail 42 is fixed to the core 16. Accordingly, the rail 42 and the core 16 remain rotationally or torsionally restrained with the housing 18 while being allowed to move axially relative to the housing 18. Although one rail 42 and slot 38 is shown in FIG. 5, any number, arrangement, or geometry may be included in order to perform the function described herein.

Without in any way limiting the scope, interpretation, or application of the claims appearing below, it will be appreciated that the embodiments of the present disclosure rotationally or torsionally limit or restrain rotational or torsional displacement, movement, or vibration of the core 16 relative to the housing 18 of the heat exchanger 14 while allowing the core 16 to thermally expand in an axial direction in order to improve durability and efficiency of the heat exchanger 14. Further, the coupler(s) 28 of various embodiments described herein is/are positioned and structured to minimize disruption of coolant flow within the housing 18, thereby further improving the efficiency and operation of the heat exchanger 14. Although the heat exchanger 14 is described herein as being utilized with the EGR system 12 of the engine 10, it will be appreciated that the heat exchanger 14 may be utilized with other fluids configured for heat exchanging. In non-limiting examples, while the first fluid is described in embodiments herein as exhaust gas and the second fluid is described in embodiments herein as coolant, the first fluid and the second fluid may include any other fluids, including a liquid and/or a gas, for heat exchange therebetween, and the heat exchanger 14 may be utilized with or for any other engine or non-engine related system, including without limitation as a charge air cooler, in an engine/powerplant cooler circuit, or in a HVAC/refrigeration system.

As used herein, “e.g.” is utilized to non-exhaustively list examples and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. A heat exchanger comprising:
a core configured to circulate a first fluid therethrough;
a housing surrounding the core, wherein the housing is configured to circulate a second fluid therethrough and across the core, wherein the first fluid is different from the second fluid, and wherein the core includes a housing interface portion whereby the core interfaces with the housing to allow rotational and axial displacement between the core and the housing; and
at least one coupler disposed between the core and the housing, wherein the at least one coupler is configured to rotationally couple the core to the housing.

2. The heat exchanger of claim 1, wherein the at least one coupler is configured to allow axial displacement between the core and the housing.

3. The heat exchanger of claim 1, wherein the at least one coupler is disposed between the core and the housing at the housing interface portion of the core.

4. The heat exchanger of claim 1, wherein the core extends axially through the housing, and the at least one coupler is disposed radially between the core and the housing.

5. The heat exchanger of claim 1, wherein the core defines a first fluid chamber configured to circulate the first fluid, and the core and the housing define a second fluid chamber configured to allow the second fluid to circulate therethrough.

6. The heat exchanger of claim 1, wherein the first fluid comprises internal combustion engine exhaust gas.

7. The heat exchanger of claim 1, wherein the second fluid comprises coolant.

8. The heat exchanger of claim 1, wherein the at least one coupler comprises at least one pin configured to rotationally couple the core to the housing and allow axial displacement between the core and the housing.

9. The heat exchanger of claim 1, wherein the at least one coupler comprises at least one slot configured to rotationally couple the core to the housing and allow axial displacement between the core and the housing.

10. The heat exchanger of claim 1, wherein the core includes a plurality of radially outer corners, wherein the at least one coupler comprises a plurality of inserts, wherein each of the plurality of inserts is disposed at each of the plurality of radially outer corners, and wherein the plurality of inserts is configured to limit rotational displacement between the core to the housing and allow axial displacement between the core and the housing.

11. The heat exchanger of claim 1, wherein the first fluid comprises internal combustion engine exhaust gas, and wherein the at least one coupler is composed of aluminum.

12. An internal combustion engine having an exhaust gas recirculation system configured to recirculate exhaust gas, the exhaust gas recirculation system comprising:
a core configured to circulate exhaust gas therethrough;
a housing surrounding the core, wherein the housing is configured to circulate coolant therethrough and in a heat-exchanging relationship with the core, and wherein the core includes a housing interface portion whereby the core interfaces with the housing to allow rotational and axial displacement between the core and the housing; and
at least one coupler disposed between the core and the housing, wherein the at least one coupler is configured to rotationally couple the core to the housing.

13. The internal combustion engine of claim 12, wherein the at least one coupler is configured to allow axial displacement between the core and the housing.

14. The internal combustion engine of claim 12, wherein the at least one coupler is disposed between the core and the housing at the housing interface portion of the core.

15. The internal combustion engine of claim 12, wherein the core is configured to circulate the exhaust gas axially through the core, and the at least one coupler is disposed radially between the core and the housing.

16. The internal combustion engine of claim 12, wherein the core defines a first fluid chamber configured to circulate the exhaust gas, and the core and the housing define a second fluid chamber configured to allow the coolant to circulate therethrough.

17. The internal combustion engine of claim 12, wherein the at least one coupler comprises at least one pin configured to rotationally couple the core to the housing and allow axial displacement between the core and the housing.

18. The internal combustion engine of claim 12, wherein the at least one coupler comprises at least one slot configured to rotationally couple the core to the housing and allow axial displacement between the core and the housing.

19. The internal combustion engine of claim 12, wherein the core includes a plurality of radially outer corners, wherein the at least one coupler comprises a plurality of inserts, wherein each of the plurality of inserts is disposed at each of the plurality of radially outer corners, and wherein the plurality of inserts is configured to limit rotational displacement between the core to the housing and allow axial displacement between the core and the housing.

20. The internal combustion engine of claim 12, wherein the at least one coupler is composed of aluminum.
